(19) United States
(12) Patent Application Publication
(10) Pub. No.: US 2002/0157226 A1
(43) Pub. Date: Oct. 31, 2002

(54) Device for handling retaining ring bolts

(76) Inventors: Thomas Hagedorn, Wedemark (DE); Torsten Gand, Garbsen (DE); Harald Knoblauch, Wunstorf (DE)

Correspondence Address: DOMINGUE & WADDELL, PLC, FNB TOWERS, 600 JEFFERSON STREET, SUITE 515, LAFAYETTE, LA, 70501, US

(21) Appl. No.: 09/958,264

(22) PCT Filed: Feb. 6, 2001
(86) PCT No.: PCT/DE01/00444

(30) Foreign Application Priority Data
Feb. 10, 2000 (DE) 200 02 354.3

(51) Int. Cl. B23P 11/00

(52) U.S. Cl. 29/243.522

(57) ABSTRACT

Apparatus for setting retaining ring bolts. The apparatus includes having gripping jaws for drawing the bolt and a sleeve with an anvil for cold working the retaining ring. A supporting device is positioned projecting beyond the anvil from the device and being movable against the force of a spring element parallel to the longitudinal direction of the bolt in the direction of the device.

The present invention relates to an apparatus for handling retaining ring bolts having gripping jaws for drawing the bolt and a sleeve having an anvil for cold working the retaining ring.

Such devices for handling retaining ring bolts according to the prior art are operating as follows:

The bolt is inserted into a bored opening which is extending through two or more flat work pieces to be connected together for example through metal sheets and the retaining ring is pushed onto the bolt. Thereafter the bolt is drawn by the device for handling the retaining ring bolts and the work pieces to be connected herewith are fixedly pressed together. During the further movement the retaining ring is deformed into the locking grooves wherein a cold working is occurring during which the retaining ring simultaneously is cold worked in the sleeve having the anvil. Doing so, the problem is occurring that after finalising the procedure the retaining ring is clamped within the anvil to such an extent, that an returning force of about 2 kN is necessary to separate the clamped retaining ring from the anvil, to be able to handle the next retaining ring bolt with the tool.

This relatively large returning force up to now only could be provided by means of a rather complicate device hydropneumatically. Such a device, however, is rather heavy and clumsy.

It is therefore the task to be solved by the present invention to provide an apparatus for handling retaining ring bolts of the above defined kind in which the clamped retaining ring can be separated from the anvil simply and without large technical expenditure. Thereby the handling device should be able to be constructed substantially more light-weight.

The task according to the invention is solved by such an apparatus for handling retaining ring bolts in which next to the anvil a supporting device is positioned, projecting beyond the anvil from the apparatus and being movable in the direction to the apparatus parallel to the longitudinal direction of the bolt against the force of a spring element.

It is especially preferred in this connection, that the supporting device is constructed as a sleeve concentrically surrounding the anvil.

The spring element preferably can be a metal screw spring or a spring element of rubber of polyurethane.

A spring element of rubber or polyurethane preferably can be constructed as a rubber sleeve concentrically positioned with respect to the anvil.

Further it is preferred that the spring element is surrounded by a concentric sleeve which simultaneously is serving as a guide for the supporting device. Thereby simultaneously the spring element is protected against environmental influences and the danger of injuries by being squeezed in a metallic screw spring is excluded respectively.

The present invention in the following is more detailly described with reference to an exemplary embodiment shown in the attached drawings. In the drawings show:

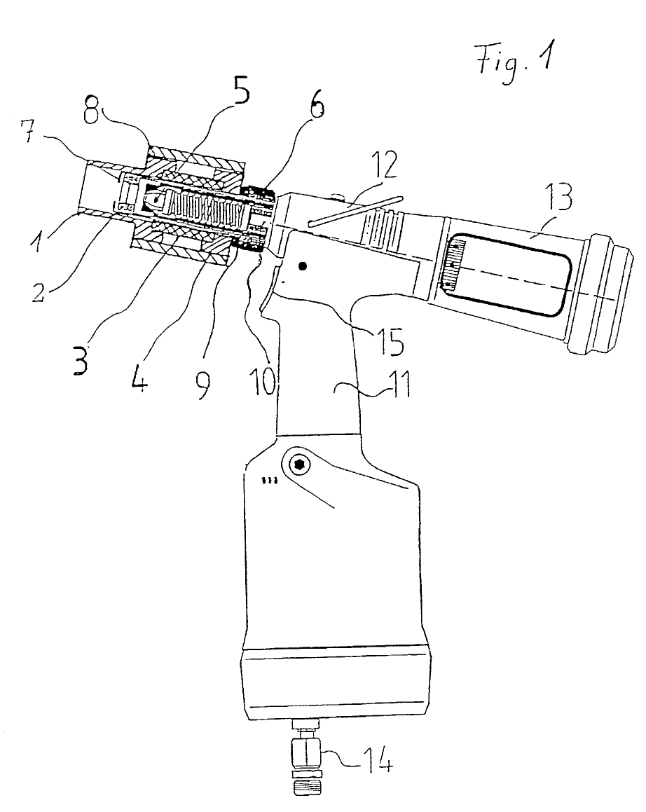

FIG. 1 an apparatus for handling retaining ring bolts according to the invention;

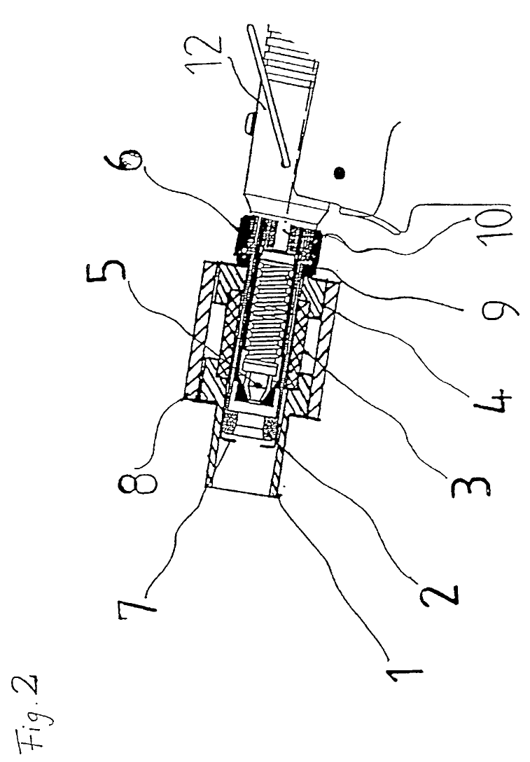

FIG. 2 a detailed representation of the apparatus according to the invention of FIG. 1; and

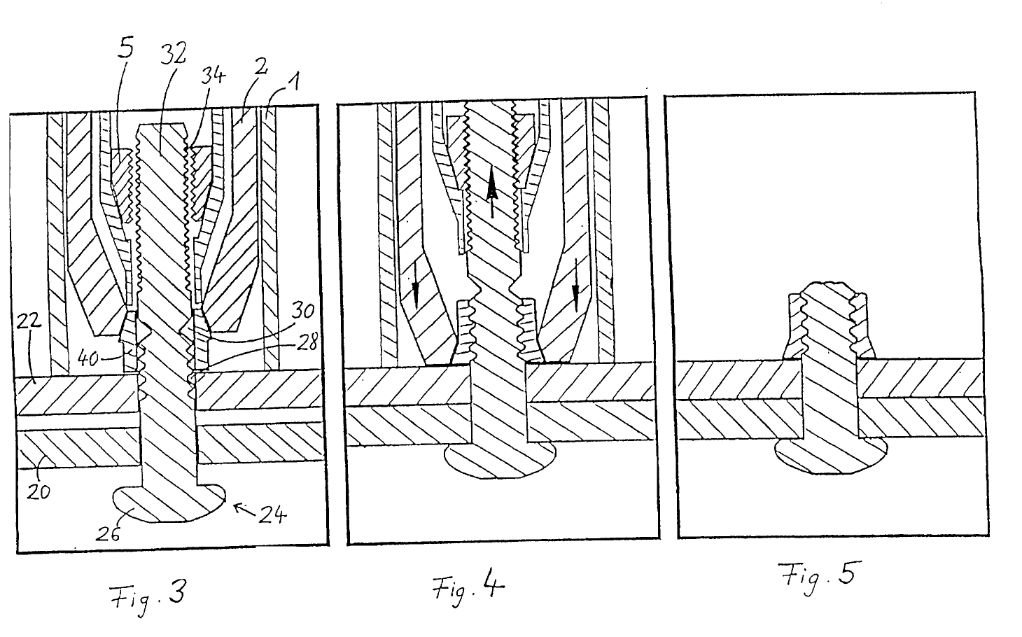

FIGS. 3 to 5 the working procedure of retaining ring bolts systems according to the prior art.

The present invention starts out from a prior art in which the apparatus for handling retaining ring bolt systems were rather complicated and heavy hydropneumatic devices which had to be provided with a special hydropneumatic return apparatus to separate the worked retaining ring which in the most cases was clamped within the anvil from the anvil after finalising the working procedure to enable the setting device to be used again.

Contrary thereto the present invention provides for a new solution by which the setting of retaining ring bolts drastically is simplified and the setting can be done with substantially lighter and simpler devices. Especially according to the invention devices for setting breakstem blind rivets which are largely used and which are obtainable substantially cheaper can be modified for setting retaining ring bolt systems.

FIGS. 1 and 2 show such a setting device for breakstem blind rivets modified for setting retaining ring bolts.

In such riveting devices for breakstem blind rivets when setting retaining ring bolts the problem is existing, that these setting devices do have a setting force of 17 kN, but the return force only being 50 N. This is naturally creating no problems when setting breakstem blind rivets. With retaining ring bolts, however, often the retaining ring is jammed in the anvil in such an extent, that a return force of about 2 kN is necessary to loosen the jammed retaining ring from the anvil.

The present invention is solving this problem by the feature that the return force is increased.

For fully explaining the function of the invention, in the following firstly it is described, how the setting of retaining ring bolt systems according to the prior art is done with reference to FIGS. 3 to 5.

FIG. 3 is showing two metal sheets 20, 22 to be joined. These are having a bore passing through both metal sheets. Into this bore a retaining ring bolt 24 is inserted. The retaining ring bolt 24 is having a head 26 which is designed similar to a screw head. The bolt 24 is passed through the bore with its end distant from the head 26. At the end distant from the head 26 the bolt 24 is having locking grooves 28, which preferably are formed like a thread. This is followed at a position more distant from -he head 26 by a break neck 30. The break neck 30 is followed by a gripping section 32. The latter has grooves 34 in its surface enabling the transmission of the corresponding pulling force onto the bolt.

After inserting the bolt into the bore through the work pieces, now either the locking ring 40 can be pushed on or the locking ring 40 already is held in the anvil of the setting device and is pushed onto the free end of the bolt 24 by the setting device. This situation is shown in FIG. 3. The joining procedure now is done by moving the gripping jaws 5 of the setting device away from the work pieces while the anvil 2 is maintained stationary. The gripping jaws 5 are closing, as shown in FIG. 4, the head 26 of the bolt 24 is contacting the work piece on the head side, simultaneously the retaining ring is contacting the opposite work piece. With a further movement of the gripping jaws 5 away from the work pieces and the movement of the anvil 2 in the direction of the work pieces, the work pieces 20, 22 are fixedly pressed together. When these are fully contacting each other, now the retaining ring 40 is cold worked by the anvil 2. Doing so, the retaining ring 40 is formed into the locking grooves 28 of the bolt 24. Simultaneously the retaining ring 40 is cold worked on its exterior side, too, by the anvil 2. By this procedure the retaining ring 40 is clamped within the anvil 2. When the anvil 2 is contacting the work piece 22, the deformation of the retaining ring 40 is finalised, the pulling force is further increasing, such, that the bolt 24 is breaking at the break neck 30. Now, however, the problem still is existing that the anvil 2 has to be drawn of the retaining ring 40 to achieve the final situation of the retaining ring bolt joining element shown in FIG. 5. To this end now the modification according to the invention of the setting device is provided. As shown in FIGS. 1 and 2, the setting device according to the invention for retaining ring bolts is derived from a riveting apparatus for breakstem blind rivets. Since such tools are especially light-weight, simple in construction and because of the manufacture in large numbers are cheap. In the embodiment shown it is a tool operated by pressurized air. The invention, however, of course can be applied to all other kinds of drive The tool is having the usual gripping jaws 5 which normally grip the stem of the breakstem blind rivet. Instead of the mouth piece, however, for setting retaining ring bolts a different construction is provided, which has been added by means of a cap nut 6 like a mouth piece for breakstem blind rivets onto the setting device.

The apparatus according to the invention for setting retaining ring bolts adjacent thereto is having a sleeve which is concentrically surrounding the gripping jaws similar to the mouth piece for breakstem blind rivets. This sleeve is leading into the anvil 2 which is serving the cold working of the retaining ring. In front of this anvil 2 a holding device 7 for the retaining rings can be provided in case these directly should be pushed on by means of the setting device. Immediately in front of the cap screw 6 an abutment ring 4 is provided carrying a guide sleeve 8 being concentrically, too, and which simultaneously is forming an abutment for an also concentrically positioned spring element 3. This spring element 3 can be a sleeve-shaped rubber or polyurethane spring or can be a metallic screw spring. On the other end of the spring element a further sleeve is mounted concentrically enclosing the anvil 2 and projecting beyond the same forwardly i.e. in the direction of the work pieces to be joined. This sleeve is guided within the sleeve 8 in such a way, that it can move backwardly in an axial direction against the force of the spring element and parallel to the longitudinal direction of the bolt. This sleeve, therefore, is a supporting device 1 and can be moved backwardly to such an extent until it is flush with the anvil 2.

When using the apparatus for setting retaining ring bolts according to the invention, this supporting device 1 is set onto the work piece 22 in the state of FIG. 3. If, as shown in FIG. 4, the anvil 2 is moved in the direction of the work piece, the supporting device is yielding backwardly guided within the sleeve 8 i.e. into the setting device wherein the spring element 3 is compressed. The force of the spring element here is chosen such, that it is not impeding the cold working of the retaining ring, but on the other hand is providing enough force after the breaking-off of the retaining ring bolt at the break neck 30 to loosen the anvil 2 from the retaining ring 40 by means of the force stored within the spring element 3. Advantageously this force of the spring element 3 is 1,5 to 3 kN.

The supporting device 1 naturally not has to be a concentric sleeve. For example, polygonal cross sections too, or a broken shape can be suitable in which the support only is occurring on a number of points on the work piece 22.

By means of the device according to the invention therefore, remaining ring bolt systems can be set by means of the substantially simpler, lighter and cheaper riveting devices for breakstem rivets. Simultaneously the working speed compared with the prior art can be increased by one third. In comparison with the apparatuses for setting retaining ring bolt systems known until now, by means of the device according to the invention a reduction in weight of more than one half is achievable. Further the setting of the retaining ring bolt systems and the manufacture of the setting devices becomes more economically.

1. Apparatus for setting retaining ring bolts having gripping jaws (5) for drawing the bolt and a sleeve with an anvil for cold working the retaining ring, characterised in that beside the anvil (2) a supporting device (1) is positioned projecting beyond the anvil 2 from the device and being movable against the force of a spring element (3) parallel to the longitudinal direction of the bolt in the direction of the device.

2. Apparatus according to claim 1, characterised in that the supporting device (1) is performed as a sleeve concentrically enclosing the anvil (2).

3. Apparatus according to claim 1 or 2, characterised in that the spring element (3) is a metallic screw spring.

4. Apparatus according to claim 1 or 2, characterised in that the spring element (3) is a rubber spring.

5. Apparatus according to claim 4, characterised in that the rubber spring is performed as a rubber sleeve positioned concentrically with respect to the anvil (2).

6. Apparatus according to any of the claims 2 to 5, characterised in that the spring element is surrounded by a concentric sleeve (8) which simultaneously is functioning as a guide for the supporting device (1).
